(19) United States
(12) Patent Application Publication
(10) Pub. No.: US 2026/0045828 A1
(43) Pub. Date: Feb. 12, 2026

(54) Energy Harvesting in Cellular Communications

(71) Applicant: Dell Products L.P., Round Rock, TX (US)

(72) Inventors: Yasser AlEryani, Kanata (CA); Satish Venkob, Mississauga (CA)

(21) Appl. No.: 18/796,189

(22) Filed: Aug. 6, 2024

(51) Int. Cl. H02J 50/00; H02J 50/40; H02J 50/80; H04B 7/0413

(52) U.S. Cl. CPC H02J 50/001; H02J 50/40; H02J 50/80; H04B 7/0413

(57) ABSTRACT

A system can facilitate broadband cellular communications with user equipment via a group of antennas of the system, wherein the group of antennas comprises multiple-input multiple-output antennas. The system can determine channel state information of user equipment for which broadband cellular communications are enabled via the group of antennas. The system can purpose an antenna element of the group of antennas for energy harvesting based on the channel state information failing to satisfy an information exchange criterion. The system can harvest, via the antenna element, non-contributory interference plus noise signals as electrical energy. The system can direct the electrical energy to a processing circuit involved in an information transmission task.

### BACKGROUND

Broadband cellular networks can facilitate network communications with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can facilitate broadband cellular communications with user equipment via a group of antennas of the system, wherein the group of antennas comprises multiple-input multiple-output antennas. The system can determine channel state information of user equipment for which broadband cellular communications are enabled via the group of antennas. The system can purpose an antenna element of the group of antennas for energy harvesting based on the channel state information failing to satisfy an information exchange criterion. The system can harvest, via the antenna element, non-contributory interference plus noise signals as electrical energy. The system can direct the electrical energy to a processing circuit involved in an information transmission task.

An example method can comprise determining, by a system comprising at least one processor that facilitates broadband cellular communications with user equipment and that comprises a group of antennas, channel state information of the user equipment. The method can further comprise configuring, by the system, an antenna element of the group of antennas for energy harvesting based on the channel state information failing to satisfy an information exchange criterion. The method can further comprise harvesting, with the antenna element, radio frequency signals as electrical energy. The method can further comprise utilizing, by the system, the electrical energy in powering the system.

An example non-transitory computer-readable medium can comprise instructions that, in response to execution, cause a system comprising a processor to perform operations. These operations can comprise determining channel state information of user equipment. These operations can further comprise configuring an antenna of antennas for energy harvesting based on the channel state information being determined not to satisfy an information exchange criterion. These operations can further comprise harvesting radio frequency signals that are received at the antenna as electrical energy. These operations can further comprise utilizing the electrical energy.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate energy harvesting in cellular communications, in accordance with an embodiment of this disclosure;

FIG. 2 illustrates an example of energy harvesting that can facilitate energy harvesting in cellular communications, in accordance with an embodiment of this disclosure;

FIG. 3 illustrates another example system architecture that can facilitate energy harvesting in cellular communications, in accordance with an embodiment of this disclosure;

FIG. 4 illustrates an example system architecture of an energy harvesting unite that can facilitate energy harvesting in cellular communications, in accordance with an embodiment of this disclosure;

FIG. 5 illustrates an example graph of energy harvesting results that can facilitate energy harvesting in cellular communications, in accordance with an embodiment of this disclosure;

FIG. 6 illustrates an example graph of energy harvesting results that can facilitate energy harvesting in cellular communications, in accordance with an embodiment of this disclosure;

FIG. 7 illustrates an example graph of energy harvesting results that can facilitate energy harvesting in cellular communications, in accordance with an embodiment of this disclosure;

FIG. 8 illustrates an example process flow that can facilitate energy harvesting in cellular communications, in accordance with an embodiment of this disclosure;

FIG. 9 illustrates another example process flow that can facilitate energy harvesting in cellular communications, in accordance with an embodiment of this disclosure;

FIG. 10 illustrates another example process flow that can facilitate energy harvesting in cellular communications, in accordance with an embodiment of this disclosure;

FIG. 11 illustrates an example block diagram of a computer operable to execute an embodiment of this disclosure.

### DETAILED DESCRIPTION

### Overview

The examples herein generally relate to fifth generation new radio (5G NR) broadband cellular communications. It can be appreciated that they can be applied to other types of broadband cellular communications, such as sixth generation (6G) technologies.

The present techniques can be implemented to facilitate enhancing the energy efficiency of large-scale multiple-input multiple-output (mMIMO) gNodeBs (gNBs, sometimes referred to as base stations) by strategically utilizing uplink (UL) energy. Energy consumption patterns of gNBs can be improved while maintaining or advancing the performance metrics of connected UL and downlink (DL) user equipments (UEs). Through the partitioning of the antenna elements of a mMIMO gNB, specific antennas can be allocated for energy harvesting or the transmission/reception of information. By harnessing the adaptability of shared MIMO antenna systems, configurable via smart antenna technologies, the present techniques can dynamically assign antenna elements based on real-time channel state information (CSI) of all connected UEs. Antennas deemed less effective for contributing to the information exchange process can be repurposed as energy harvesting (EH) elements, proficient at converting non-contributory interference plus noise signals into usable electrical energy. The harvested energy can then be efficiently redirected to power the processing circuits involved in UL and DL information transmission tasks. This can facilitate a self-sustaining gNB infrastructure, and also benefits with regard to optimizing antenna resources for improved network performance and energy conservation.

Growth in wireless communication demands has prompted development of more energy-efficient technologies to sustainably scale network infrastructure. The present techniques can facilitate enhancing energy efficiency within mMIMO gNBs by harnessing energy from UL transmissions. By reallocating antenna elements between UL energy harvesting and information transmission/reception functions, the present techniques can facilitate maintaining or improving the performance of connected UL and DL UEs while reducing the energy footprint of the gNBs.

Energy consumption in cellular networks can be a growing concern, with base stations accounting for a substantial portion of this consumption. The advent of fifth generation (5G) technology and mMIMO systems can further accentuate this issue due to the increased number of antennas and the associated processing power required. Prior approaches have generally treated interference and noise as detrimental by-products to be minimized. In contrast, the present techniques leverage these seemingly non-utilitarian components as a source for energy harvesting.

With mMIMO technologies, gNBs can be equipped with a large number of antennas, facilitating gains in spectral efficiency and network capacity. It can be that these systems, however, have not been fully optimized for energy efficiency. The present techniques can be used to implement an adaptive antenna allocation mechanism that dynamically designates certain mMIMO antenna elements to harvest energy from the UL transmissions, such as from ambient radio frequency (RF) noise and interference. This energy can then be repurposed to offset the power requirements of the gNB's operational activities.

Shared antenna systems, enabled by smart antenna technologies, can permit a flexible configuration of each antenna element to function either in UL or DL modes. By evaluating the current CSI for connected UEs, the present techniques can facilitate intelligently determining which antennas are less critical for information transfer processes. Those selected antennas can then be switched to energy harvesting mode, capturing the energy from interference plus noise signals.

Relative to prior approaches, the present techniques can offer a new way to reduce the operational energy of gNBs and also enhance an overall network sustainability. The harvested energy, once converted into electrical energy through a system's energy harvesting elements, can be utilized to support processing needs for UL/DL information transmission operations. In summary, the present techniques can facilitate a self-sufficient, energy-optimized gNB infrastructure that aligns with the directives of green and sustainable wireless communication networks.

5G networks can offer a transformative leap in the realm of wireless communication relative to prior networks, offering unprecedented data rates, reduced latency, and massive connectivity for a burgeoning array of devices and services. However, this technological evolution can have come at a cost of significantly increased energy requirements, especially at the gNBs that can form the backbone of 5G infrastructure. As 5G networks deploy mMIMO systems to meet high-capacity demands, the energy consumption of gNBs can escalate due to a sheer increase in the number of active antenna elements and the associated signal processing complexities.

Furthermore, a dense deployment of gNBs to ensure coverage and capacity can lead to an increase in signal interference, which has generally been viewed in prior approaches as a challenge to be mitigated. Interference management can be critical in maintaining system performance, yet the prior approaches of simply minimizing interference can overlook the potential energy that could be harvested from these signals. With environmental concerns and operational costs rising, the telecommunications industry can face a need to devise energy-efficient solutions for gNB operations without compromising on network performance.

That is, the following problems can be addressed through the present techniques. One problem can relate to rising energy consumption. The enhanced throughput and low-latency communications promised by 5G mMIMO gNBs (relative to prior network technologies) can require active and continuous operation of a large number of antenna elements and signal processing units. This can result in a substantial increase in energy consumption, escalating operational costs, and contributing to the environmental footprint of wireless networks.

Another problem can relate to limited power supplies for some private wireless scenarios. Within a context of private wireless networks, a gNB can be carried at a back of a mobile vehicle (such as military applications) with a limited or non-external power supply. This can put a pressure on the whole communication process. Searching for alternative sustainable energy sources can be a dire need in such scenarios.

Another problem can relate to underutilized interference. In dense network deployments, the interference from overlapping signals can be elevated. While this can deteriorate the quality of communication, it can be a largely untapped energy source. The ambient RF energy, which can include both interference and noise, can be a byproduct of high traffic loads and can be reconstituted as a valuable resource if harvested efficiently.

The present techniques can address these problems by introducing an adaptive antenna allocation system that redefines the role of mMIMO antennas in gNBs. By employing advanced smart antenna technologies, the present techniques can dynamically configure individual antenna elements to operate either in communication (UL/DL information transfer) or energy harvesting modes. This allocation can be governed by a real-time assessment of the CSI for all connected UEs. Antennas that cannot contribute positively to the current communication process due to suboptimal conditions or excessive interference can be repurposed for energy harvesting. This harvested energy, once converted through the system's energy conversion elements, is then fed back to power the gNB's operations.

This approach can facilitate a reduction in the energy consumption of gNBs, and also offer a pathway to a more sustainable and cost-effective network operation. By turning a challenge into an opportunity, the present techniques can pave the way for an innovative solution to the increasing energy demands of the next generation of wireless networks, contributing to the larger goal of energy-neutral or even energy-positive cellular infrastructure.

The present techniques can be implemented to provide features not found in prior approaches to wireless communications, such as in a context of energy management and efficiency in 5G networks with mMIMO systems. Examples of these features include:
Dynamic Antenna Element Reallocation: The present techniques can facilitate dynamically reallocating mMIMO antenna elements at gNBs between their traditional communication role (UL/DL transmission) and energy harvesting from ambient interference and noise.
Real-time CSI-Based Optimization: The present techniques can utilize real-time Channel State Information (CSI) to assess and optimize the allocation of each antenna element, ensuring that underperforming elements for data transfer can be instead used for energy harvesting.
Intelligent Interference Utilization: In contrast to prior approaches that aim to minimize interference, the present techniques can capitalize on interference by converting it into electrical energy, thereby repurposing a potential drawback into a beneficial resource.
Shared Antenna System Adaptability: The present techniques can leverage a flexibility of shared antenna systems, employing smart antenna technologies to facilitate rapid reconfiguration in response to varying network conditions and UE requirements.
Enhanced Energy Efficiency: By harvesting energy that would otherwise be wasted, the present techniques can address concern of rising energy consumption in 5G gNBs, leading to more sustainable and cost-effective network operations.
Contribution to Self-Sustaining Infrastructure: The present techniques can facilitate development of self-sustaining gNBs that can partially offset their energy needs through harvested ambient energy, aligning with future green cellular network goals.
System and Apparatus Design: The present techniques comprise a system and apparatus design for implementing the proposed energy harvesting and antenna allocation technique.
Scalability and Flexibility: The present techniques can be scalable with the number of antenna elements, and flexible enough to adapt to various deployment scenarios and traffic conditions in 5G and beyond 5G networks.

These innovations of the present techniques can collectively contribute to a paradigm shift in how energy is managed within the cellular network infrastructure, emphasizing efficiency, sustainability, and the effective use of available resources.

A complexity analysis of the present techniques can be as follows. This complexity analysis pertaining to adaptive antenna allocation for energy harvesting in 5G massive MIMO (mMIMO) systems can encompass a computational burden and algorithmic intricacy involved in real-time decision-making for antenna allocation. The system's complexity can be primarily dictated by the processes of Channel State Information (CSI) acquisition, optimization algorithms for antenna allocation, energy harvesting conversion, and dynamic system reconfiguration.

The process of obtaining the CSI can inform the antenna allocation decision. In a mMIMO system, the CSI can be represented as a matrix H with dimensions U×N, where U is the number of single-antenna UEs and N is the number of antenna elements at the gNB. The complexity of obtaining the CSI can be formulated as:

$${C}_{csi} = O ( U \times N ) .$$

Once the CSI is obtained, the system can determine which antennas are to be allocated for energy harvesting. This decision can be based on an optimization problem, such as the following example:

$$maximize η ( EH ) \cdot {\sum }_{i = 1}^{{N}_{EH}} {P}_{i}^{harvested}$$

$$subject to : {\sum }_{u = 1}^{U} {C}_{u} ( U , N - {N}_{EH} ) \leq {C}_{min}$$

where, N_{EH}+N_{comm}=N, with N_{EH} is the number of antennas used for EH, N_{comm} is the number of antennas used for wireless communication.

$${P}_{i}^{harvested}$$

is the amount of energy harvested from the i^{th} antenna. η(EH) is the energy harvesting efficiency.

The complexity of this optimization problem can involve both continuous (power levels) and discrete (antenna allocation) variables. In some examples, a heuristic or greedy approach can be used to approximate the solution, and it can be possible for the complexity to be reduced to polynomial time. For an exact solution, the problem can become nondeterministic polynomial (NP)-hard. In some examples, ML techniques can be implemented to solve a problem of maximizing energy harvested (or sufficiently capturing energy).

The energy conversion process can involve translating the RF energy harvested by the antennas into electrical energy that can be used by a gNB. The complexity of this process, C_{conv}, can be influenced by the efficiency and speed of the RF-to-DC converters and the associated circuitry.

Dynamic reconfiguration of antenna elements from communication to energy harvesting (or vice versa) can involve switching circuitry and, in some examples, recalibration of the RF paths. This complexity is denoted by C_{reconf} and can depend on the hardware design and reconfiguration techniques used.

The overall complexity Cₜₒₜₐₗ of the system is the summation of the complexities of each individual process:

$${C}_{total} = {C}_{CSI} + {C}_{opt} + {C}_{conv} + {C}_{reconf}$$

According to the present techniques, a gNB can be configured to harvest energy from surrounding undesired UL signals, originated from both connected and interfering UEs. This energy can be stored in a battery to be used later by the same gNB to power its DL data transmission/processing. Such an energy saving can be useful for certain scenarios at which ultra dense gNBs are assembled on small geographical area with lots of interfering undesired UL signals. Another scenario in which the present techniques can be used is with private wireless networks at which the gNB conducted on a moving object to provide a private network connection for several distributed UEs. In such a scenario, the ability to acquire more energy for DL transmission and gNB processing can be crucial, given that the gNB can have a limited power supply.

### Example Architectures, Graphs, Etc.

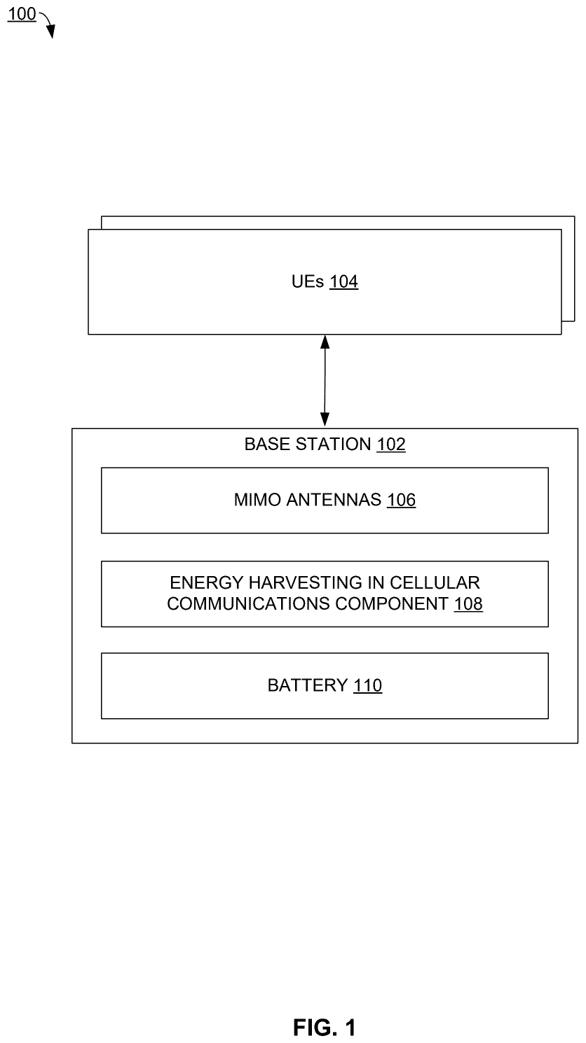

FIG. 1 illustrates an example system architecture 100 that can facilitate energy harvesting in cellular communications, in accordance with an embodiment of this disclosure.

System architecture 100 comprises base station 102, UEs 104, MIMO antennas 106, energy harvesting in cellular communications component 108, and battery 110.

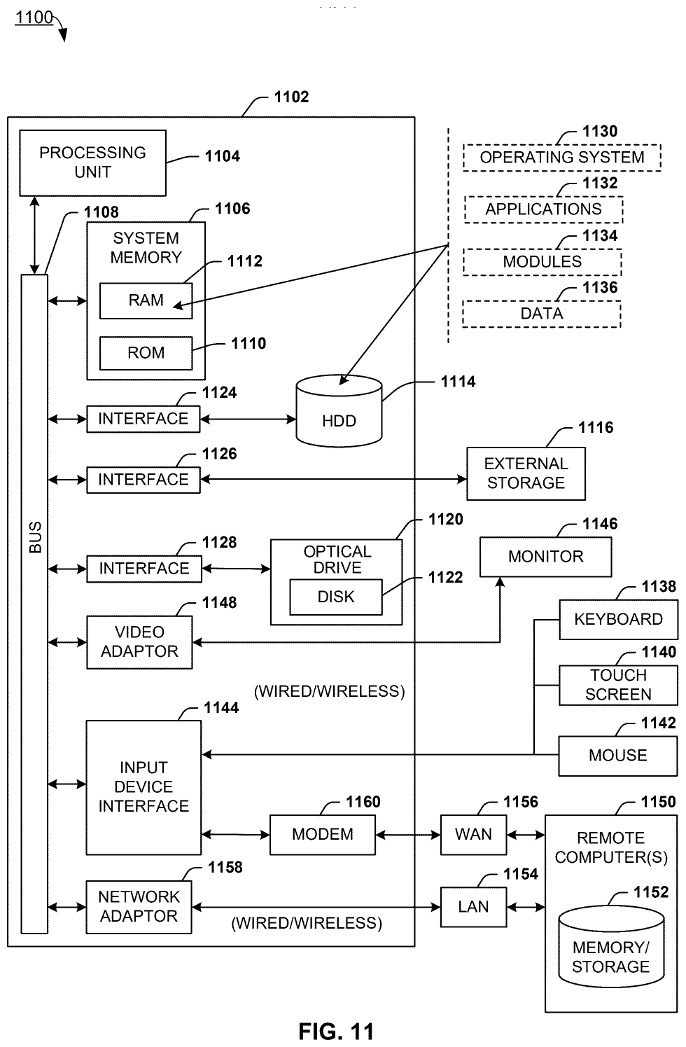

Each of base station 102 and/or UEs 104 can be implemented with part(s) of computing environment 1100 of FIG. 11.

Base station 102 can comprise a broadband cellular network that facilitates broadband communications with UEs 104. As part of this, base station 102 can utilize some antennas of MIMO antennas 106 to conduct UL and/or DL communications with UEs of UEs 104. And base station 102 can utilize some antennas of MIMO antennas 104 to harvest UL communications from UEs of UEs 104 for energy, which energy harvesting in cellular communications component 108 can direct to be stored in battery 110 and/or use to power base station 102.

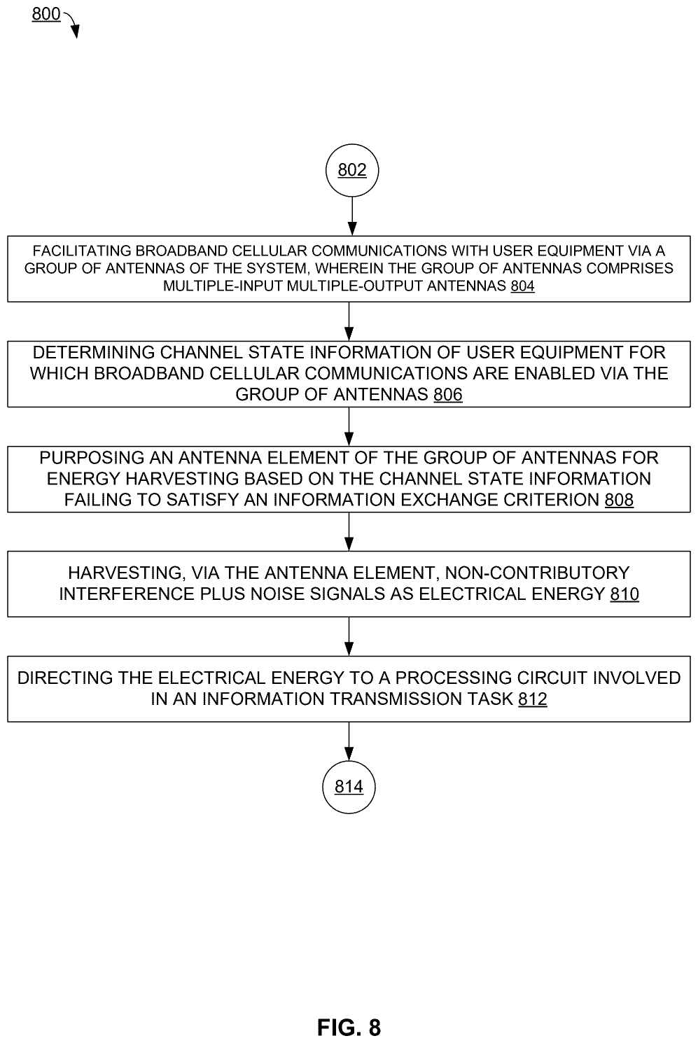

In some examples, energy harvesting in cellular communications component 108 can implement part(s) of the process flows of FIGS. 8-10 to facilitate energy harvesting in cellular communications.

It can be appreciated that system architecture 100 is one example system architecture for energy harvesting in cellular communications, and that there can be other system architectures that facilitate energy harvesting in cellular communications.

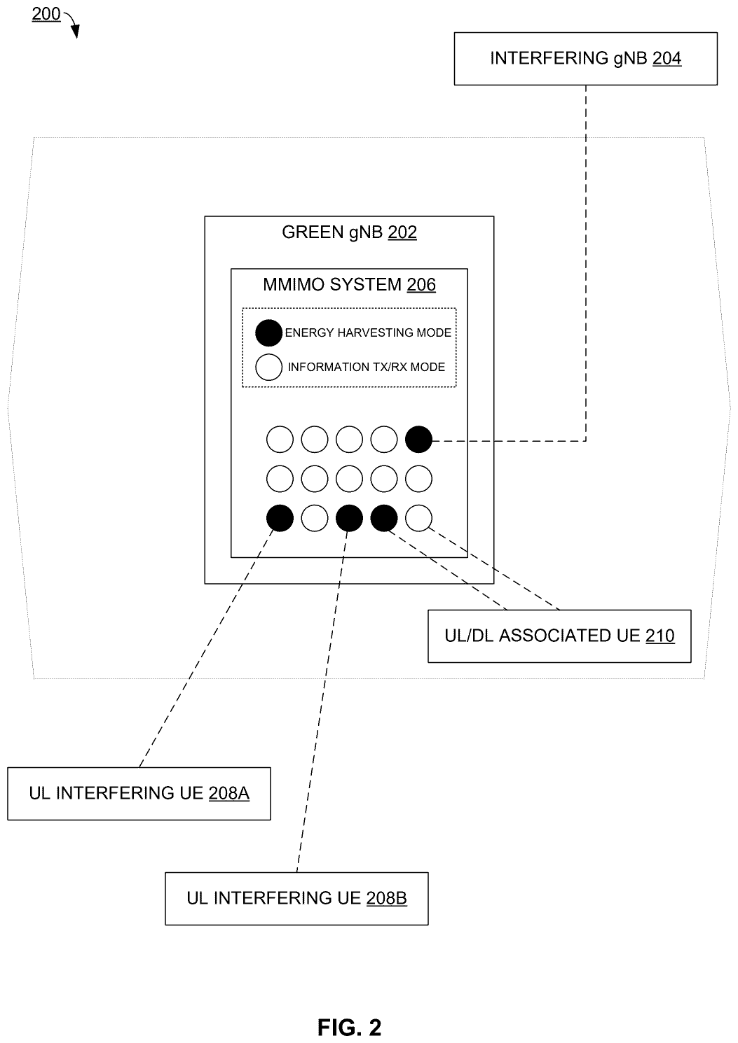

FIG. 2 illustrates an example 200 of energy harvesting that can facilitate energy harvesting in cellular communications, in accordance with an embodiment of this disclosure. In some examples, part(s) of example 200 can be implemented by part(s) of system architecture 100 of FIG. 1 to facilitate energy harvesting in cellular communications.

Example 200 comprises green gNB 202, interfering gNB 204, mMIMO system 206, UL interfering UE 208A, UL interfering UE 208B, and UL/DL associated UE 210.

In example 200, green gNB 202 conducts UL and DL information exchange with UL/DL associated UE 210 while harvesting energy from RF signals originated by UL interfering UE 208A, and UL interfering UE 208B.

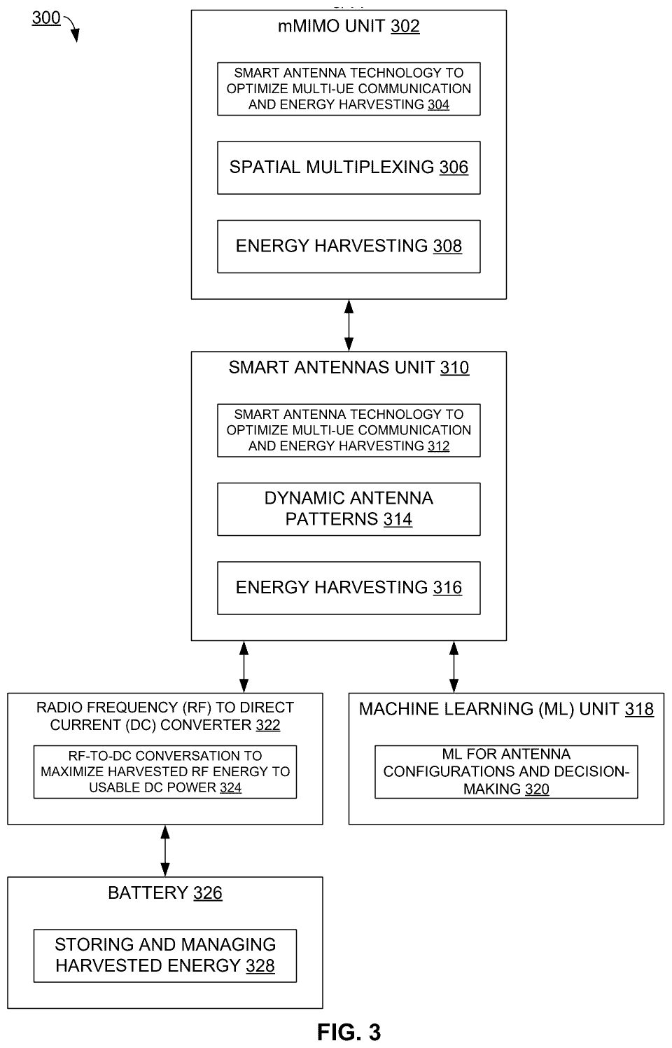

FIG. 3 illustrates another example system architecture 300 that can facilitate energy harvesting in cellular communications, in accordance with an embodiment of this disclosure. In some examples, part(s) of system architecture 300 can be implemented by part(s) of system architecture 100 of FIG. 1 to facilitate energy harvesting in cellular communications.

System architecture 300 can comprise a gNB, such as a “green gNB” as described herein. System architecture 300 comprises mMIMO unit 302, smart antenna technology to optimize multi-UE communication and energy harvesting 304, spatial multiplexing 306, energy harvesting 308, smart antennas unit 310, smart antenna technology to optimize multi-UE communication and energy harvesting 312, dynamic antenna patterns 314, energy harvesting 316, machine learning (ML) unit 318, ML for antenna configurations and decision-making 320, radio frequency (RF) to direct current (DC) converter 322, RF-to-DC conversation to maximize harvested RF energy to usable DC power 324, battery 326, and storing and managing harvested energy 328.

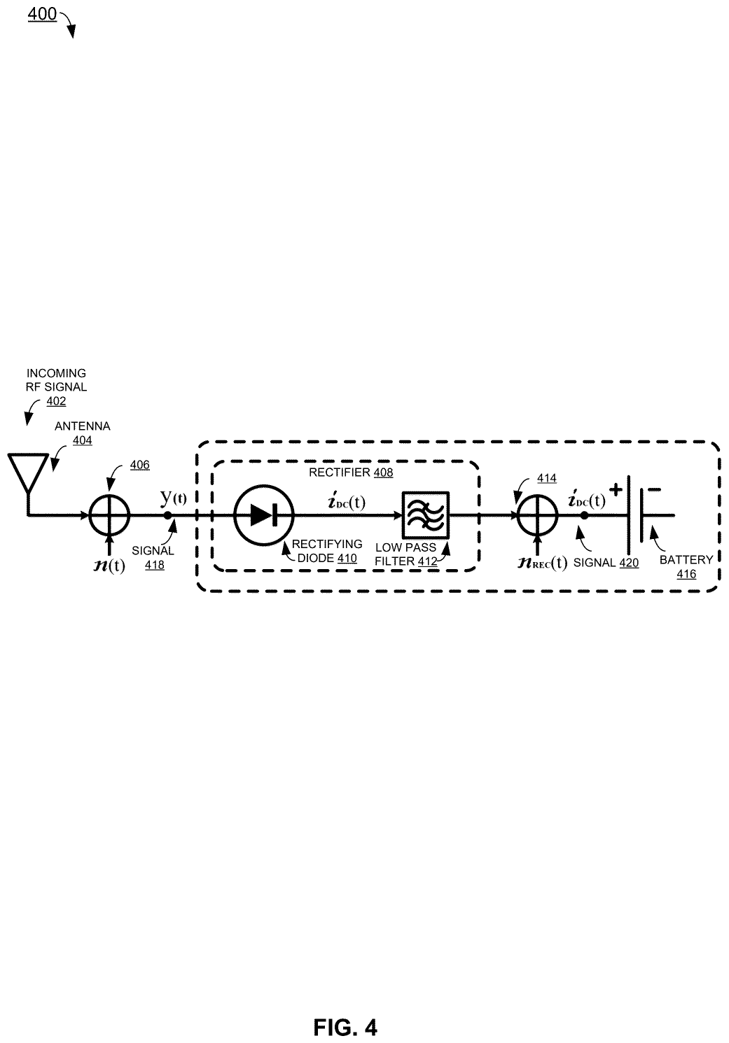

FIG. 4 illustrates an example system architecture 400 of an energy harvesting unite that can facilitate energy harvesting in cellular communications, in accordance with an embodiment of this disclosure. In some examples, part(s) of system architecture 40 can be implemented by part(s) of system architecture 100 of FIG. 1 to facilitate energy harvesting in cellular communications.

System architecture 400 comprises incoming RF signal 402, antenna 404, adder 406, rectifier 408, rectifying diode 410, low pass filter 412, adder 414, battery 416, signal 418, and signal 420.

The present techniques can facilitate a system and technology for dynamically reallocating antenna elements in 5G mMIMO gNBs for energy harvesting from ambient interference and noise, alongside traditional communication tasks. Such a system can comprise several components and processes that work in harmony to achieve dual objectives of enhancing network efficiency and reducing energy consumption.

System architecture 400 can comprise the following components.

RF Energy Harvesting Units: These units can be connected to a subset of antenna elements and include circuits for RF-to-DC conversion, energy storage, and management to ensure harvested energy is stored and utilized efficiently.

The received signal at the j\hat{ }th EH unit (signal 418) can be given by:

$${y}_{j} ( t ) = \sqrt{2} Real \{ {\sum }_{i = 0}^{K} \sqrt{{h}_{ji} {P}_{i}} {x}_{i} ( t ) {e}^{j ( 2 π ft + {θ}_{i} )} + {\hat{n}}_{j} ( t ) {e}^{j 2 π ft} \}$$

where xᵢ(t)=Aᵢ(t)e^{jϕ}^{ᵢ}^{(t)}, where K is the total number of received RF signals. \hat{n}ⱼ(t)e^{j2πft} can be the additive white Gaussian noise (AWGN) at the input of j^{th} EH antenna element. The output current of a Schottky diode (at signal 420) can be given by:

$${i}_{DC} ( t ) = {I}_{s} ( {e}^{α y ( t )} - 1 ) = {a}_{1} y ( t ) + {a}_{2} {y}^{2} ( t ) + {a}_{3} {y}^{3} ( t ) + …$$

where Iₛ denotes the saturation current, a denotes the reciprocal of the thermal voltage of Schottky diode, and the coefficients aₙ are given by

$${a}_{n} = \frac{{I}_{s} {α}^{n}}{n !} ,$$

n=1, 2, . . . . Accordingly,

$${i}_{DC} ( t ) = {( {\sum }_{i = 0}^{K} {A}_{i} ( t ) \sqrt{P} A ( t ) cos ( {ϕ}_{i} ( t ) + {θ}_{i} ) + {n}_{I} ( t ) )}^{2} + {( {\sum }_{i = 0}^{K} {A}_{i} ( t ) \sqrt{P} A ( t ) sin ( {ϕ}_{i} ( t ) + {θ}_{i} ) )}^{2} + {n}_{r e c} ( t ) .$$

Under an assumption of independent and identically distributed random variables (i.i.d.), the amount of energy Eⱼ (in joules) harvested at the j^{th} EH antenna element during a transmission period of T sec is given by:

$${E}_{j} = {η}_{j} TE {i}_{DC , j} ( t ) {P}_{i} = {η}_{j} T {\sum }_{i = 0}^{K} {\vert {g}_{ji} \vert}^{2} {P}_{i}$$

Where ηⱼ is the energy conversion efficiency, Pᵢ is the transmission power of the i^{th} interfering node and git is the channel state information between the i^{th} antenna node and j^{th} EH antenna element.

Alternatively, the amount of power harvested at the j^{th} antenna can be given by

$${P}_{i}^{harvested} = \frac{{E}_{i}}{T}$$

Overall, at a certain time slot with duration T, the amount of power harvested at a green gNB with K antenna elements selected for EH at that time duration can be given by:

$${P}_{total}^{harvested} = {\sum }_{j = 1}^{K} {P}_{j}$$

Antenna Array: The mMIMO antenna array can comprise a large number of antenna elements capable of both transmitting/receiving communication signals and harvesting energy from ambient RF sources.

Real-time Processing Unit: This can comprise a high-speed processing unit capable of analyzing CSI, performing optimization for antenna allocation, and managing the dynamic reconfiguration of the antenna elements.

Switching Network: This can comprise fast-switching network that can dynamically connect antenna elements to either the communication transceivers or the RF energy harvesting units based on the allocation decisions.

Control System: A central control system can orchestrate the present techniques, making decisions based on the optimization techniques' outputs, and overseeing the operation of the switching network.

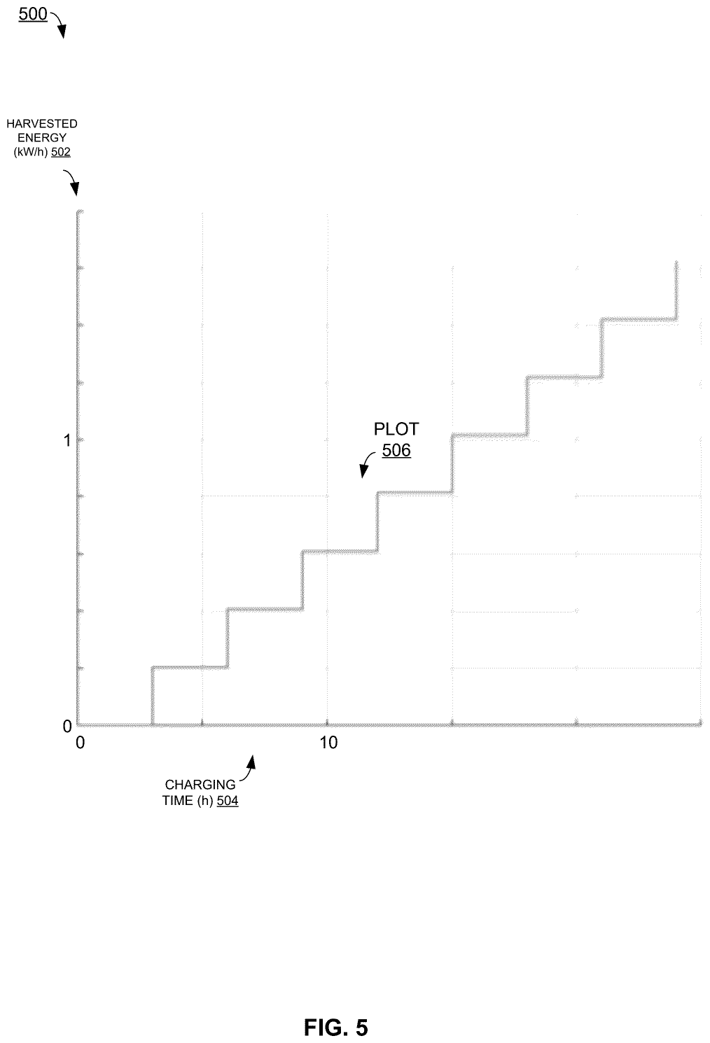

FIG. 5 illustrates an example graph 500 of energy harvesting results that can facilitate energy harvesting in cellular communications, in accordance with an embodiment of this disclosure. In some examples, part(s) of graph 500 can be implemented by part(s) of system architecture 100 of FIG. 1 to facilitate energy harvesting in cellular communications.

Graph 500 comprises harvested energy (kilowatts per hour (kW/h)) 502, charging time (h) 504, and plot 506.

In FIGS. 5-7, the present techniques are simulated with the following parameters:

| Parameter | Value |
|---|---|
| Number of gNB Antennas | 3 (sectors) * 128 (antenna per sector) |
| Average Number of EH | 0.7 (0.3 can serve only connected UE |
| Antennas | for data transmission) |
| Charging Time | 24 hours (one day) |
| Number of UEs | 1,000 (both connected and interfering) |
| Number of antennas per UE | 1, 4, 8 |
| EH Conversion Efficiency | 0.95 |
| Operating Bandwidth (BW) | 100 million cycles per second (MHz) |
| Thermal Noise | −174 decibels relative to one milliwatt |
| | (dBm)/cycle per second (Hz) |

In a scenario of FIG. 5, a green gNB according to the present techniques was able to harvest up to 1.8 KW/h, during 24 hours of operations.

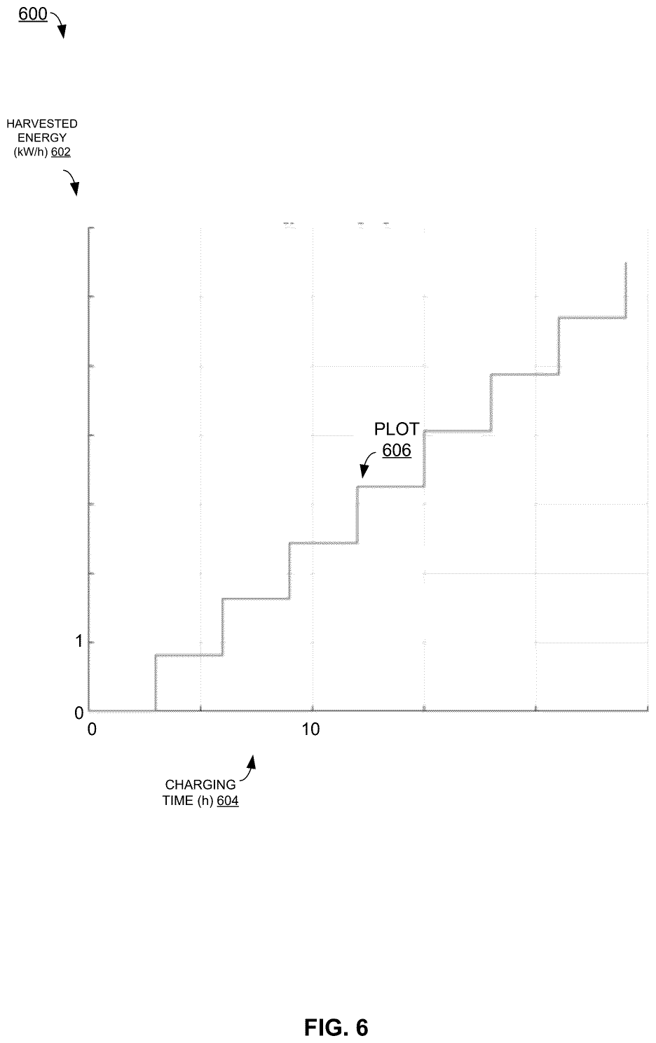

FIG. 6 illustrates an example graph 600 of energy harvesting results that can facilitate energy harvesting in cellular communications, in accordance with an embodiment of this disclosure. In some examples, part(s) of graph 600 can be implemented by part(s) of system architecture 100 of FIG. 1 to facilitate energy harvesting in cellular communications.

Graph 600 comprises harvested energy (kW/h) 602, charging time (h) 604, and plot 606.

In FIG. 6, the number of antennas per UE is 4, compared to 1 in FIG. 5.

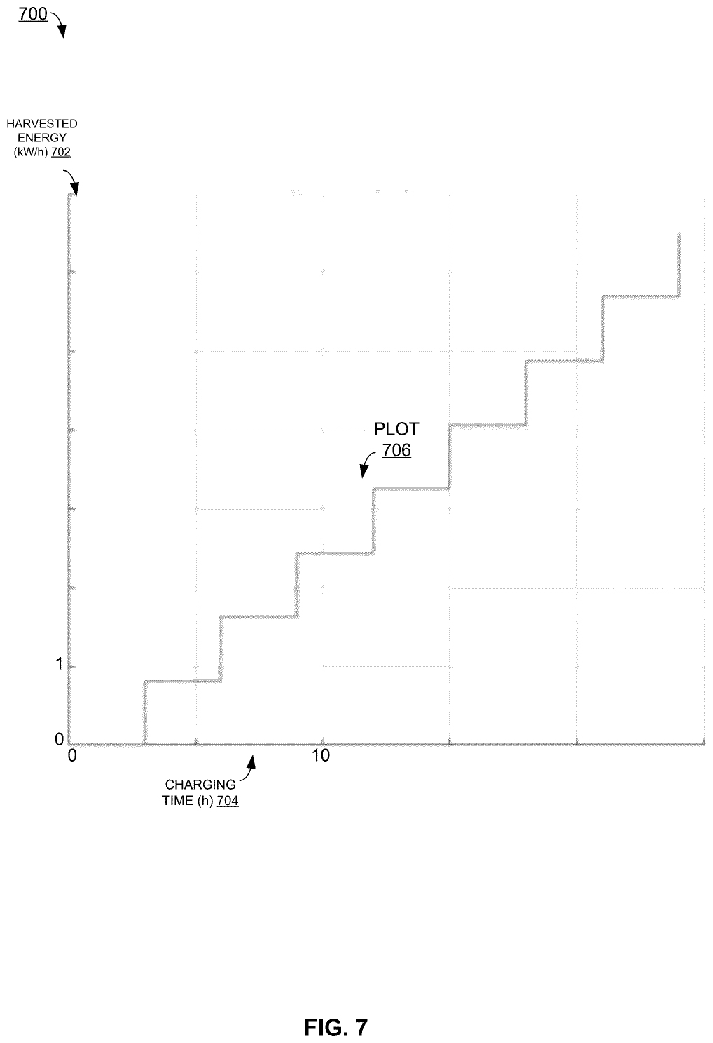

FIG. 7 illustrates an example graph 700 of energy harvesting results that can facilitate energy harvesting in cellular communications, in accordance with an embodiment of this disclosure. In some examples, part(s) of graph 700 can be implemented by part(s) of system architecture 100 of FIG. 1 to facilitate energy harvesting in cellular communications.

Graph 700 comprises harvested energy (kW/h) 702, charging time (h) 704, and plot 706.

In FIG. 7, there are 8 antennas per UE, and FIG. 7 illustrates an amount of energy harvested by a green gNB according to the present techniques. This amount of harvested energy could be enough to power a macro gNB within an urban area for a day.

### Example Process Flows

FIG. 8 illustrates an example process flow 800 for energy harvesting in cellular communications, in accordance with an embodiment of this disclosure. In some examples, one or more embodiments of process flow 800 can be implemented by system architecture 100 of FIG. 1, or computing environment 1100 of FIG. 11.

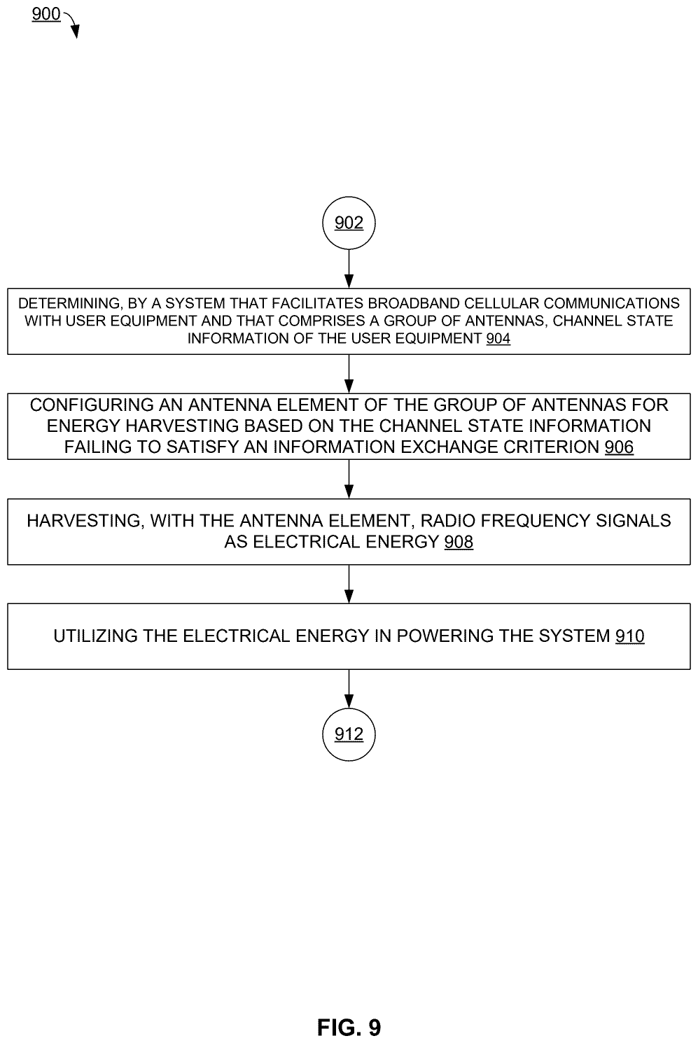

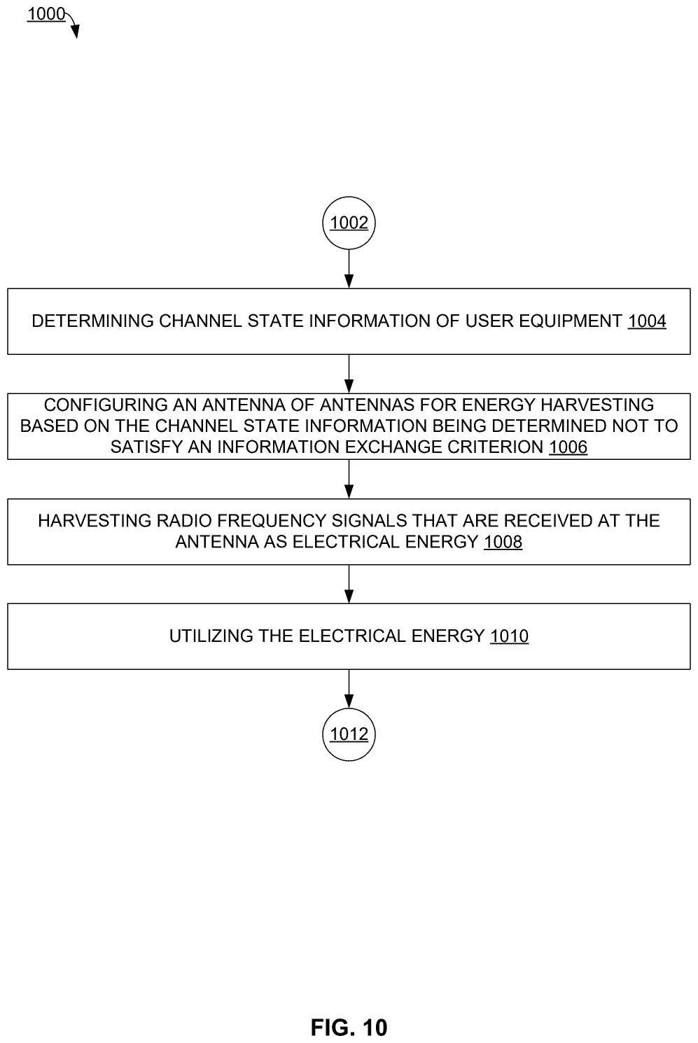

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 900 of FIG. 9, and/or process flow 1000 of FIG. 10.

Process flow 800 begins with 802, and moves to operation 804.

Operation 804 depicts facilitating broadband cellular communications with user equipment via a group of antennas, wherein the group of antennas comprises multiple-input multiple-output antennas. That is, using the example of FIG. 1, process flow 800 can be implemented by base station 102.

In some examples, the group of antennas comprises a massive multiple-input multiple-output configuration.

After operation 804, process flow 800 moves to operation 806.

Operation 806 depicts determining channel state information of user equipment for which broadband cellular communications are enabled via the group of antennas. Continuing with the example of FIG. 1, this group of antennas can be MIMO antennas 106, and CSI reports can be determined for each antenna that is communicating with a UE of UEs 104.

After operation 806, process flow 800 moves to operation 808.

Operation 808 depicts purposing an antenna element of the group of antennas for energy harvesting based on the channel state information failing to satisfy an information exchange criterion. That is, where there is sufficient interference, instead of using the antenna for communications, it can be used to harvest RF signals as electrical energy.

In some examples, operation 808 comprises dynamically configuring at least one antenna element of the group of antennas to switch between a communication mode and an energy harvesting mode. That is, individual antenna elements can be dynamically configured to operate either in a communication (UL/DL information transfer) mode or an energy harvesting mode.

After operation 808, process flow 800 moves to operation 810.

Operation 810 depicts harvesting, via the antenna element, non-contributory interference plus noise signals as electrical energy. This can comprise using the antenna element of operation 808 to harvest RF signals to be converted into electrical energy.

In some examples, the harvesting is performed with respect to uplink transmissions. In some examples, the harvesting is performed with respect to ambient radio frequency noise and interference.

After operation 810, process flow 800 moves to operation 812.

Operation 812 depicts directing the electrical energy to a processing circuit involved in an information transmission task. Continuing with the example of FIG. 1, this can include using the electrical energy to power base station 102 and/or storing it in battery 110 (for later use in powering base station 102).

In some examples, the processing circuit involved in the information transmission task comprises an uplink transmission circuit or a downlink transmission circuit.

In some examples, a system that implements process flow 800 omits an external power supply. That is, the present techniques can be implemented in a private wireless network scenario where the gNB can be transmitted on a vehicle and have a limited external power supply or no external power supply.

After operation 812, process flow 800 moves to 814, where process flow 800 ends.

FIG. 9 illustrates an example process flow 900 for energy harvesting in cellular communications, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 800 of FIG. 8, and/or process flow 1000 of FIG. 10.

Process flow 900 begins with 902, and moves to operation 904.

Operation 904 depicts determining, by a system that facilitates broadband cellular communications with user equipment and that comprises a group of antennas, channel state information of the user equipment. In some examples, operation 904 can be implemented in a similar manner as operations 804-806 of FIG. 8.

In some examples, the determining of the channel state information of the user equipment comprises determining respective channel state information of the channel state information for respective antenna elements of the group of antennas. That is, the present techniques can utilize real-time CSI to assess and optimize allocation of each antenna element, so that elements that are underperforming for data transfer can instead be used for energy harvesting.

In some examples, the determining of the channel state information is performed based on a current measurement with respect to currently connected user equipment of the user equipment. That is, there can be a real-time assessment of CSI for connected UEs.

After operation 904, process flow 900 moves to operation 906.

Operation 906 depicts configuring an antenna element of the group of antennas for energy harvesting based on the channel state information failing to satisfy an information exchange criterion. In some examples, operation 906 can be implemented in a similar manner as operation 808 of FIG. 8.

In some examples, the configuring of the antenna element is performed based on determining that the antenna element fails to satisfy a communications criterion based on a suboptimal condition or a threshold amount of interference. That is, it can be that antennas that cannot contribute positively to the current communication process due to suboptimal conditions or excessive interference can be repurposed for energy harvesting.

After operation 906, process flow 900 moves to operation 908.

Operation 908 depicts harvesting, with the antenna element, radio frequency signals as electrical energy. In some examples, operation 908 can be implemented in a similar manner as operation 810 of FIG. 8.

In some examples, the harvesting of the radio frequency signals as the electrical energy comprises converting the radio frequency signals into the electrical energy via an energy conversion element of the system. That is, harvested energy, once converted through energy conversion elements, can be fed back to power a gNB's operations.

In some examples, the harvesting of the radio frequency signals as the electrical energy comprises converting the radio frequency signals into a direct current via a radio frequency-to-direct current converter of the system. That is, RF-to-DC converters and associated circuitry can be implemented as part of the harvesting.

After operation 908, process flow 900 moves to operation 910.

Operation 910 depicts utilizing the electrical energy in powering the system. In some examples, operation 910 can be implemented in a similar manner as operation 812 of FIG. 8.

In some examples, the utilizing of the electrical energy in powering the system comprises storing at least part of the electrical energy in a battery of the system. Using the example of FIG. 1, this can be battery 110.

After operation 910, process flow 900 moves to 912, where process flow 900 ends.

FIG. 10 illustrates an example process flow 1000 for energy harvesting in cellular communications, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 800 of FIG. 8, and/or process flow 900 of FIG. 9.

Process flow 1000 begins with 1002, and moves to operation 1004.

Operation 1004 depicts determining channel state information of user equipment. In some examples, operation 1004 can be implemented in a similar manner as operations 804-806 of FIG. 8.

After operation 1004, process flow 1000 moves to operation 1006.

Operation depicts 1006 configuring an antenna of antennas for energy harvesting based on the channel state information being determined not to satisfy an information exchange criterion. In some examples, operation 1006 can be implemented in a similar manner as operation 808 of FIG. 8.

In some examples, operation 1006 comprises selecting the antenna for the configuring based on a machine learning model that is trained to operate on an amount of energy harvested from respective antennas of the antennas and a measure of energy harvesting efficiency of the antennas. This can be similar to ML unit 318 of FIG. 3.

In some examples, operation 1006 comprises selecting the antenna for the configuring based on a heuristic antenna selection or a greedy antenna selection.

In some examples, the configuring of the antenna of the antennas for energy harvesting is performed based on an objective for the system to satisfy at least a first communication metric and a second energy harvesting metric. This can be similar to smart antenna technology to optimize multi-UE communication and energy harvesting 304 and/or smart antenna technology to optimize multi-UE communication and energy harvesting 312 of FIG. 3.

After operation 1006, process flow 1000 moves to operation 1008.

Operation 1008 depicts harvesting radio frequency signals that are received at the antenna as electrical energy. In some examples, operation 1008 can be implemented in a similar manner as operation 810 of FIG. 8.

In some examples, the harvesting of the radio frequency signals that are received at the antenna as the electrical energy comprises passing the radio frequency signals through a rectifier that comprises a rectifying diode and a low pass filter. This can be similar to rectifier 408 of FIG. 4.

In some examples, the rectifier connects the antenna and a battery. These can be similar to antenna 404 and battery 416 of FIG. 4.

After operation 1008, process flow 1000 moves to operation 1010.

Operation 1010 depicts utilizing the electrical energy. In some examples, operation 1010 can be implemented in a similar manner as operation 812 of FIG. 8.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102 and/or UEs 104 of FIG. 1.

In some examples, computing environment 1100 can implement one or more embodiments of the process flows of FIGS. 8-10 to facilitate energy harvesting in cellular communications.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
facilitating broadband cellular communications with user equipment via a group of antennas of the system, wherein the group of antennas comprises multiple-input multiple-output antennas;
determining channel state information of user equipment for which broadband cellular communications are enabled via the group of antennas;
purposing an antenna element of the group of antennas for energy harvesting based on the channel state information failing to satisfy an information exchange criterion;
harvesting, via the antenna element, non-contributory interference plus noise signals as electrical energy; and
directing the electrical energy to a processing circuit involved in an information transmission task.

2. The system of claim 1, wherein the processing circuit involved in the information transmission task comprises an uplink transmission circuit or a downlink transmission circuit.

3. The system of claim 1, wherein the harvesting is performed with respect to uplink transmissions.

4. The system of claim 1, wherein the harvesting is performed with respect to ambient radio frequency noise and interference.

5. The system of claim 1, wherein the group of antennas comprises a massive multiple-input multiple-output configuration.

6. The system of claim 1, wherein the system omits an external power supply.

7. The system of claim 1, wherein the operations further comprise:
dynamically configuring at least one antenna element of the group of antennas to switch between a communication mode and an energy harvesting mode.

8. A method, comprising:
determining, by a system comprising at least one processor that facilitates broadband cellular communications with user equipment and that comprises a group of antennas, channel state information of the user equipment;
configuring, by the system, an antenna element of the group of antennas for energy harvesting based on the channel state information failing to satisfy an information exchange criterion;
harvesting, with the antenna element, radio frequency signals as electrical energy; and
utilizing, by the system, the electrical energy in powering the system.

9. The method of claim 8, wherein the determining of the channel state information is performed based on a current measurement with respect to currently connected user equipment of the user equipment.

10. The method of claim 8, wherein the configuring of the antenna element is performed based on determining that the antenna element fails to satisfy a communications criterion based on a suboptimal condition or a threshold amount of interference.

11. The method of claim 8, wherein the harvesting of the radio frequency signals as the electrical energy comprises:
converting the radio frequency signals into the electrical energy via an energy conversion element of the system.

12. The method of claim 8, wherein the determining of the channel state information of the user equipment comprises:
determining respective channel state information of the channel state information for respective antenna elements of the group of antennas.

13. The method of claim 8, wherein the utilizing of the electrical energy in powering the system comprises:
storing at least part of the electrical energy in a battery of the system.

14. The method of claim 8, wherein the harvesting of the radio frequency signals as the electrical energy comprises:
converting the radio frequency signals into a direct current via a radio frequency-to-direct current converter of the system.

15. A non-transitory computer-readable medium comprising instructions that, in response to execution, cause a system comprising at least one processor to perform operations, comprising:
determining channel state information of user equipment;
configuring an antenna of antennas for energy harvesting based on the channel state information being determined not to satisfy an information exchange criterion;
harvesting radio frequency signals that are received at the antenna as electrical energy; and
utilizing the electrical energy.

16. The non-transitory computer-readable medium of claim 15, wherein the operations further comprise:
selecting the antenna for the configuring based on a machine learning model that is trained to operate on an amount of energy harvested from respective antennas of the antennas and a measure of energy harvesting efficiency of the antennas.

17. The non-transitory computer-readable medium of claim 15, wherein the operations further comprise:
selecting the antenna for the configuring based on a heuristic antenna selection or a greedy antenna selection.

18. The non-transitory computer-readable medium of claim 15, wherein the harvesting of the radio frequency signals that are received at the antenna as the electrical energy comprises:
passing the radio frequency signals through a rectifier that comprises a rectifying diode and a low pass filter.

19. The non-transitory computer-readable medium of claim 18, wherein the rectifier connects the antenna and a battery.

20. The non-transitory computer-readable medium of claim 15, wherein the configuring of the antenna of the antennas for energy harvesting is performed based on an objective for the system to satisfy at least a first communication metric and a second energy harvesting metric.
